(19) United States
(12) Patent Application Publication
(10) Pub. No.: US 2010/0109257 A1
(43) Pub. Date: May 6, 2010

(54) METHOD FOR THE PRODUCTION OF FLAT SEALS, AND FLAT SEAL

(76) Inventor: Klaus Schmitt, Grunebach (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/594,058

(22) PCT Filed: Feb. 20, 2008
(86) PCT No.: PCT/DE08/00306

§ 371 Date: Sep. 30, 2009

(30) Foreign Application Priority Data
Mar. 31, 2007 (DE) 10 2007 015 690.3

(51) Int. Cl. F02F 11/00; F16J 15/02; B23P 11/00

(52) U.S. Cl. 277/592; 277/654; 29/432

(57) ABSTRACT

Disclosed is a method for mechanically connecting flat seals comprising at least two layers. In said method, the individual layers are placed in the area of a tool, at least one punch that has an approximately circular cross-section partially cuts the layers at defined points of the respective connection zone, and at least some of the remaining material is deformed outside the respective cut zone to form bent zones such that the respective cut zone is round and the respective bent zone is straight. Burrs of at least one of the layers are effectively connected to the material of at least one other layer in order to form a removable clamping connection, said burrs being formed in the cut zone.

The invention relates to a method for the mechanical connecting of flat gaskets having at least two layers.

A metallic gasket can be learned from DE 198 51 066 A1, which is designed such that it is located between opposite surfaces of a cylinder block and a cylinder head. The metallic gasket comprises a pair of elastic metal plates, which are furnished with first boring holes designed corresponding to the cylinder bore and beads formed along the circumferences of the first boring holes. In addition, a compensating element is provided, which is furnished with the first boring holes opposite the second boring holes and which is laminated between the elastic metal plates. The elastic metal plates have connection elements, in which the metal plates and the compensating element are connected to each other by caulking. A punch is applied, which mechanically deforms the material in the respective connecting area of the metal plates as well as of the compensating element. With the aid of another punch an outwardly effective plastic yielding can be generated in the area of the respective layers, through which a firm connection of the individual layers is generated.

The invention is based on the task of providing a method for the mechanical connecting of flat gaskets, such as cylinder head gaskets, flange gaskets or the like, having at least two sites, in which the connection can be realized in the simplest manner without additional materials or connection elements.

Furthermore, a flat gasket, particularly a multi-layered metallic cylinder head gasket, should be provided, in which a detachable connection of the individual layers to one another should be possible.

The task is solved by a method for the mechanical connecting of flat gaskets, having at least two layers, while the individual layers are positioned in the area of a tool, at least one piercing punch with an approximately circular cross section that partially cuts the layers in defined sites of the respective connection area and outside of the respective cutting area at least parts of the residual material are deformed with formation of bending areas, in such a way, that the respective cutting area is designed rounded and the respective bending area is designed linearly, in which in the cutting area are formed burrs of at least one of the layers are brought into mechanical connection for the formation of a detachable clamp connection with the material of at least another layer.

Advantageous further developments of the method according to the present invention can be learned from the associated methodological subsidiary claims.

This task is also solved by a flat gasket, comprising at least two layers, which have similar hole patterns, in which the individual layers are connected to each other in a detachable manner by clamping, in which the respective connection area has an approximately circular cross section and in defined sites has cutting areas and outside of the cutting areas bending areas, in which the respective cutting area is designed rounded and the respective bending area is designed linearly and in the cutting areas are formed burrs of at least one of the layers impressed into the material of at least one other layer, are interlocked respectively with other burrs of the other layer.

Advantageous further developments of the flat gasket according to the present invention can be learned from the associated objective subsidiary claims.

In comparison to the prior art according to DE 198 51 066 A1, a detachable connection of the individual layers of the flat gasket produced by clamping, particularly of a cylinder head gasket, thus operates, so that during the production process of the flat gasket, particularly of the cylinder head gasket, if necessary, existing defective layers can be replaced, without the layers, which are technically sound, having to be disposed of.

The individual, particularly metallic, layers of the flat gasket are connected mechanically to each other in a kind of punching process, however, can be detached in pre-definable sites. For this a piercing punch is flattened and rounded off in several sites (preferably three sites), so that no cuts can take place at these sites. In these flattened and rounded off areas the material in the respective connection area is merely clamped and mechanically deformed. In the residual areas of the piercing punch the respective layer is cut during the pressing process at defined sites (preferably three sites), in such a way, that burrs still remain, which are pressed either under pressure effect into another layer, or come into mechanical connection with burrs of another layer. Through both processes a clamping connection of the individual layers is achieved. The cutting areas are shaped by their dimensioning, so that they are designed as a percentage smaller or maximally equally large, as the bending area running essentially linearly.

It is ensured contingent on this cutting process, that the diameter of the piece punched out of one of the layers is somewhat larger than the boring of another layer, so that the aforesaid clamping of the piece punched out occurs in the other layer.

With the method according to the present invention up to six (metallic) layers can be connected to each other in a detachable manner, in which the connection of the layers is implemented at different sites of the flat gasket in a process step.

As already addressed, the connection of the individual layers can be detached again temporarily, so that after replacement of a defective by a technically sound layer the connection can be subsequently reproduced under pressure effect.

The object of the invention is depicted by means of a preferred embodiment and is described as follows:

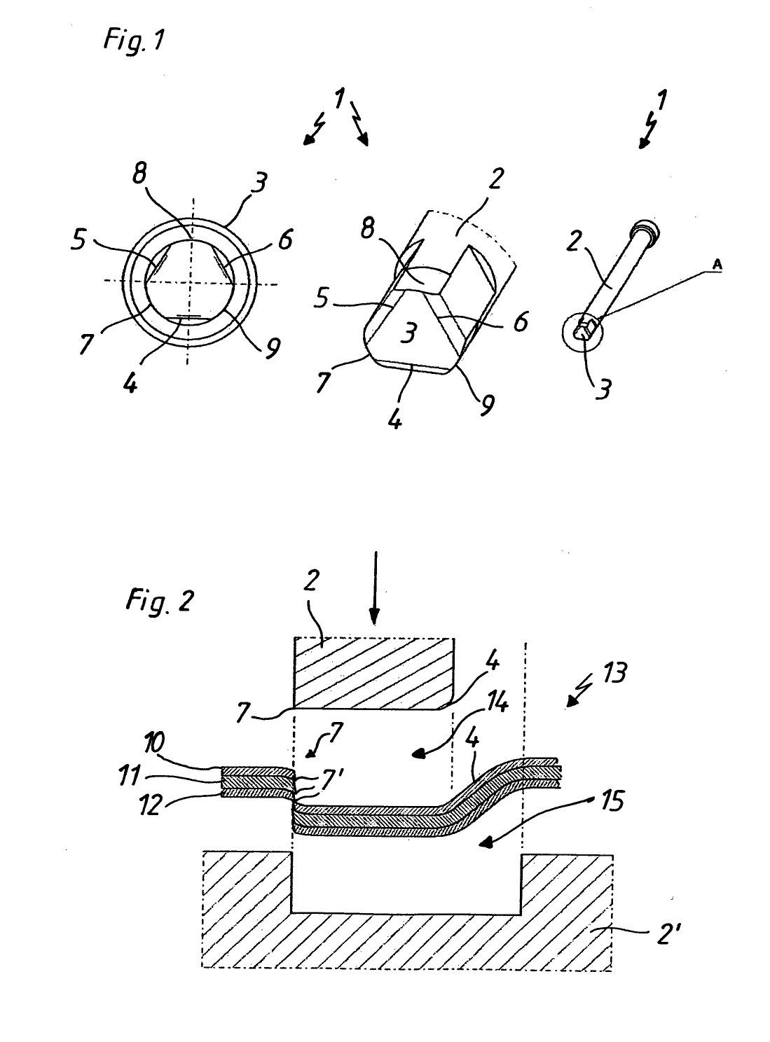

FIG. 1 shows schematic diagrams of the tool which can be used for the production of a connection area in different views or sections;

FIG. 2 shows a single depiction of the respective cutting area and bending area in a connection area.

FIG. 1 shows the schematic design of an individual cutting tool 1 in a partial perspective depiction. The cutting tool 1 comprises an elongated piercing punch 2 with an approximately circular lower hole surface 3. Through arrangement of several such piercing punches 2 in the area of a step-up station connection areas can be produced at several sites of the flat gasket, such as, for example, of a cylinder head gasket, not depicted here. The piercing punch 2 is flattened on three sides 4, 5, 6 and rounded off at three other sides 7, 8, 9. Each connection area thus forms on the one hand cutting areas 7 to 9 and on the other hand bending areas 4 to 6.

FIG. 2 shows a partial view of a flat gasket 13 consisting in this example of three metallic layers 10, 11. 12, designed as a cylinder head gasket. With the method according to the present invention up to six layers can be brought into mechanical connection to each other. The cylinder head gasket 13 comprises combustion chamber through-borings, media through-borings as well as screw through-borings, which are not depicted. The metallic layers 10 to 12 of the cylinder head gasket 13 are connected mechanically with each other at different sites 14 by clamping, however, are detachable. The individual connection area 14 distinguishable here comprises cutting areas 7 and bending areas 4, in which this connection area 14 has in each case three cutting areas 7 to 9 as well as three bending areas 4 to 6 in alternating arrangement.

In the respective connection area 14 a mechanical bracing of materials (burrs 7′) of the layers 10 to 12 takes place, in which the individual layers 10, 11, 12 are connected to each other in a detachable manner by clamping. Furthermore, the piercing punch 2 is distinguishable with the cutting area 7 as well as the bending area 4. With the reference numeral 2′ a lower tool element is designated, which has a corresponding recess 15. Through pressure effect (arrow) the respective connection area 14 is generated in such a way that the layers 10 to 12 are pressed into the recess 15, in which at the same time the rounded cutting areas 7 to 9 and the bending areas 4 to 6 running linearly are generated.

If during the manufacture of the cylinder head gasket it emerges that an individual layer of the connection is defective, the layers 10-12 can be separated without any difficulty. The defective layer is replaced by a technically sound layer and connected again to the other layers through pressure effect.

1. Method for the mechanical connection of flat gaskets, having at least two layers, while the individual layers are positioned in the area of a tool, at least one piercing punch with an approximately circular cross section partially cuts the layers at defined sites of the respective connection area and outside of the respective cutting area at least parts of the residual material are deformed with formation of bending areas, in such a way, that the respective cutting area is designed rounded and the respective bending area is designed linearly, in which in the cutting area formed burrs of at least one of the layers are brought into mechanical connection for the formation of a detachable clamp connection to the material of at least one other layer.

2. Method according to claim 1, wherein the burrs of a first layer are pressed into the material of another layer.

3. Method according to claim 1, wherein the burrs of a first layer are brought into mechanical connection to burrs of another layer.

4. Method according to one claim 1, wherein in the respective connection are a at least two cutting areas and at least two bending areas an formed.

5. Method according to claim 1, wherein the piercing punch is designed flattened and rounded off for the production of the respective cutting area and bending area at at least two, particularly three sites.

6. Method according to claim 1, wherein the individual layers are connected to each other in a process step at several sites.

7. Method according to claim 1, wherein the replacement of defective layers the mechanical connection of the layers is detached, the defective layer is replaced, and the mechanical connection is reproduced by pressure effect.

8. Method according to claim 1, wherein the layers are connected to each other in a border area of the flat gasket.

9. Flat gasket, comprising at least two layers, which have similar hole patterns, in which the individual layers are connected to each other in a detachable manner by clamping, in such a way, that the respective connection area has an approximately circular cross section and in defined sites has cutting areas and outside of the cutting areas has bending areas, in which the respective cutting area is designed rounded and the respective bending area is designed linearly and in the cutting area formed burrs of at least one of the layers pressed into the material of at least another layer, are interlocked respectively with other burrs of the other layer.

10. Flat gasket according to claim 9, wherein the connection areas are provided in the border areas of the flat gasket.

11. Flat gasket according to claim 9, wherein each connection area contains at least two, particularly three cutting areas and at least two bending areas.

12. Flat gasket according to claim 9, wherein the cutting areas and bending areas are arranged in an alternating manner in the respective connection area.

13. Flat gasket according to claim), wherein the gasket comprises a cylinder head gasket for an internal combustion engine.

14. The method of claim 5, wherein the at least two sites comprise three sites.

15. Flat gasket according to claim 11, wherein there are three of said sites.
